(19) United States
(12) Patent Application Publication
(10) Pub. No.: US 2020/0134710 A1
(43) Pub. Date: Apr. 30, 2020

(54) Computer System for Creating Apples to Apples Comparision of Multiple Bids

(71) Applicants: Jennifer Rothwell-Reese, Murrieta, CA (US); Kathy E Hennry, Kingston, WA (US); Vicki Tortorelli, Boise, ID (US); Kenneth Scott Thomas, Boise, ID (US)

(72) Inventors: Jennifer Rothwell-Reese, Murrieta, CA (US); Kathy E Hennry, Kingston, WA (US); Vicki Tortorelli, Boise, ID (US); Kenneth Scott Thomas, Boise, ID (US)

(21) Appl. No.: 16/668,606

(22) Filed: Oct. 30, 2019

Related U.S. Application Data
(60) Provisional application No. 62/752,822, filed on Oct. 30, 2018.

(51) Int. Cl. G06Q 30/08; G06Q 40/04; G06Q 30/06; G06Q 40/06

(52) U.S. Cl. CPC G06Q 30/08; G06Q 40/06; G06Q 30/0601; G06Q 40/04

(57) ABSTRACT

A contractor bidding system gets initial bids with line items. The line items are combined to create a bid package template using line items from each of a plurality of initial bids from different bidders. Each trade can have a number of different items that can be included in the bid. Using the example of painting, for example, there can be supplies, stripping, masks, and the like. Other items might be included in the bid or excluded from the bid or alternates to the bid. The bid template can select which items are included in the bid or excluded from the bid so that when the final bids come they all include or exclude the same items.

This application claims priority from Provisional Application No. 62/752,822, filed Oct. 30, 2018, the entire contents of which are herewith incorporated by reference.

### BACKGROUND

Bidding for contracts is typically carried out in certain fields, such as in construction. For example, in the construction business, a general contractor often solicits bids to carry out a certain enumerated task based on plans and specifications for a project.

A general contractor will typically obtain bids from each of multiple subcontractors for each of different aspects of the project, e.g., from each trade.

Contractors may receive bids from multiple different companies for the same trade, for example painting or electricial. Each bidder submitting a bid includes their interpretation of what the plans and specifications call for, within their trade.

At the time that the bids are presented, the general contractor often knows some limited amount about the project, and is learning about the project as the bids are submitted. Each bid, however, has typically looked completely different. Moreover, it is difficult for the general contractor to compare the bids, since they are each in a different format and may each include different items.

### SUMMARY OF THE INVENTION

The inventor recognized that systems to compare trade bids exist. However, the inventor recognizes that there is no known system which allows apples to apples comparisons of bids by breaking the bids down into multiple line items, using the initial bids themselves to create the line items, to specify exactly what parts of the bid are included, what is excluded, and then to request a final bid, using the line items that were created from each of the multiple bids that were obtained. In this way, variances between the received bids can be eliminated.

According to an embodiment as described herein, a system is described to allow a bid receiver to receive bids from the same trade, in a way that accounts for variances between those bids, and enables the equalized bids to be compared, and to select one of the bids after they are compared.

Embodiments described herein describe a system which eliminates variances between similar scope bids, and combines the bids and related data to generate a combined list of all received bids.

### BRIEF DESCRIPTION OF THE DRAWINGS

In the Drawings:

FIG. 1 is an illustration of an online platform used with the embodiments described herein;

FIG. 2 shows a flowchart of a method to facilitate elimination of variances between same scope bids, in accordance with some embodiments;

FIG. 3 shows an exemplary UI allowing one or more bidder to submit a bid, in accordance with some embodiments;

FIG. 4 shows an exemplary UI to allow a bid receiver to finalize a bid, and send the final bid to the one or more bidders, in accordance with some embodiments;

FIG. 5 shows a flowchart of a method to facilitate elimination of variances between same scope bids by a company, in accordance with some embodiments;

FIG. 6 shows an exemplary UI to allow a bid receiver to compare one or more received bids from a combined list in accordance with some embodiments;

FIG. 7 shows an exemplary UI to allow a bidder to review a final bid with final prices and costs, in accordance with some embodiments; and

FIG. 8 is a block diagram of a computing device for implementing embodiments.

### DETAILED DESCRIPTION

The present application describes a machine and system which allows carrying out aspects of creating, viewing and editing customized bids, including facilitating determination of variances between bids of different scope. In an embodiment, the online platform may be called eJoist, which may include an online social collaboration network for the construction industry. As described herein, the online platform can include bid management, project plans, specifications, and other documents all of which can be stored online.

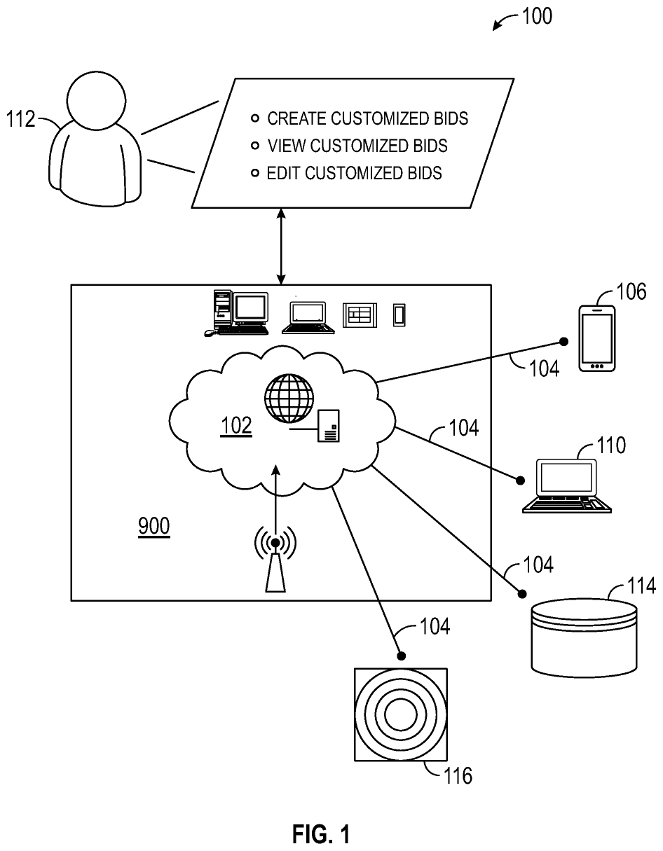

FIG. 1 shows a block diagram of the programmed computers which communicate with one another in order to carry out the functions of the present application. The platform 100 may operate, for example, on a centralized server 102, which can be a cloud computing service such as Amazon Web Services. The server 102 can also communicate with other computing devices including mobile devices 106 e.g. a smart phone, laptop or tablet computer, other electronic devices 110 such as desktop computers, distributed databases or external databases 114, as well as sensors 106. Each of the communications can be over a communication network 104 which can be a wireless or wired networks such as the Internet.

Users of the online platform 100 may include contractors, administrators, and end users of the system. FIG. 1 shows the user 112 accessing the online platform 100 through a web-based software application which communicates with the centralized server 102. In one embodiment, the web-based software application may be a website, or may alternatively be a web application or mobile application.

In operation, the online platform 100 may be configured through the operations on the online platform to obtain information from each of the bids in order to form all the line items from all of the bids into one list which forms a revised bid. The revised bid includes all of the desired line items from all of the bids which were originally received, thus eliminating variances between the bids. After the bids are obtained, the system can combine all the bids and the related data and generate a combined list of all the received bids.

In one embodiment, the user 112 may wish to enlist one or more contractors for a construction project. In this embodiment, the user can use the online platform 100 to specify details of the construction project in a way that forces bidders to bid on the specific scope project. The contractors can provide their bids for the construction project by describing the services along with the corresponding prices for those services.

The online platform 100 receives the bids and related details from bidder devices.

Further, the online platform 100 may review the one or more bid and related details which are selected for review, and may generate a combined updated list of all the items lists from all the selected bids, the related details, requirements and specifications, for the new bid to be placed. Further, the receiver device may receive the bids and the related details selected for review, from the online platform 100, and may compare the bids and related details, and select items from the one or more bids, that may be added to a final bid. Further, the receiver device may make the comparison and may then select each line item as an inclusion, an exclusion or an alternate.

The bid items selected for inclusion, may be added to the final bid.

The bid items selected for exclusion, are not added to the final bid. The items selected for alternate, may be added to the final list, but may not surely be included in the bid, depending on the alternate price as well.

Further, before sending the final bid and related details, back to the original bidder devices, a new bid due date may be selected. The final bid and the related details may be transmitted to the online platform 100.

An important feature of this embodiment is the elimination of variances between bids by multiple bidders by using the processor in the server 102 (or some other processor) to equalize the scope of the bids.

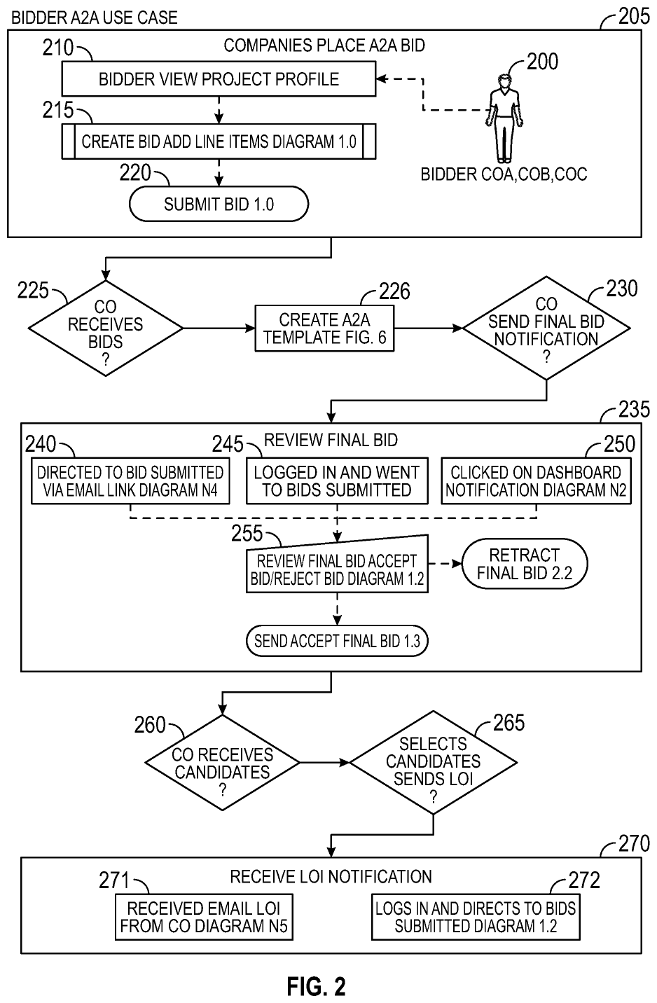

FIG. 2 illustrates a flowchart that is carried out by one of the processors in the system.

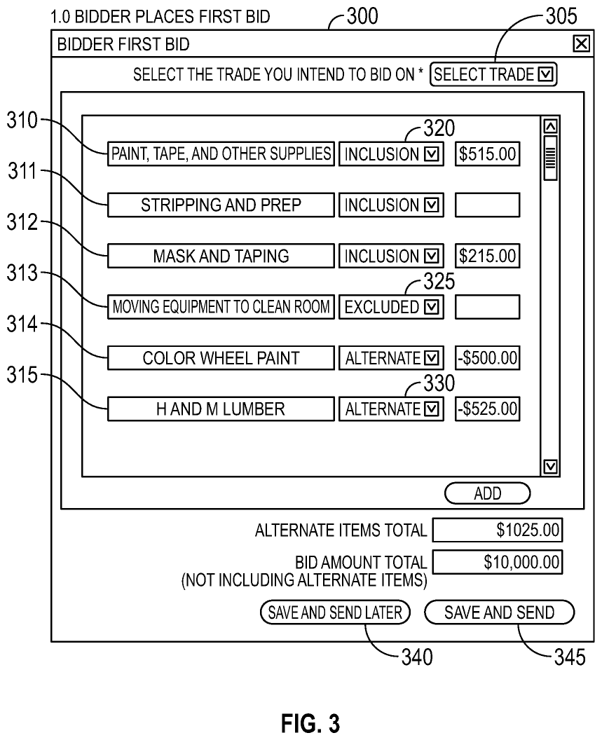

FIG. 2 shows a bidder 200 using the online system 205 to receive details of the bid from the online platform. The bidder 200 first views the project profile at 210. This includes a scope of work to be bid on. The bid itself is developed by the bidder at 215 by adding line items, as shown in FIG. 3 and explained herein. The bidder is constrained to use the form in FIG. 3 to place their first bid. For each of a plurality of items, the bidder types in line items that will be included in the bid, marks those line items as inclusions, exclusions or alternates, and marks prices for the items.

The bidder is forced to place their initial bid on this initial bid template. The bidding template 300 includes a drop down menu 305 which allows specifying the trade for which the user is submitting the bid. In the embodiment given, this bid will be for painting. The template then allows the bidder to specify line items for different services or products that the contractor has specified for that trade. For each of these services or products, the bidder can place a bid amount.

Here, the template shows paint tape and supplies 310, stripping and prep 311, masking tape in 312, moving equipment 313, color wheel painting 314, and lumber 315. For each of these products or services, the bidder selects whether they want this to be included in the bid, excluded from the bid, or an alternate part of the bid. In this embodiment, bids parts that are included are shown such as 320, exclusions shown at 325, meaning that they are not including this item, such as not including the equipment to clear the room, and alternatives shown as 330, which can be considered options that a contractor could either accept or not accept.

Once the user/bidder has finished filling out this form, they can either save that for later at 340, or send it at 345.

The bid, referred to as bid 1.0 because it is the first iteration of the bid, is then submitted at 220 (returning to FIG. 2 and the general flowchart therein). 225 the contractor receives the bid.

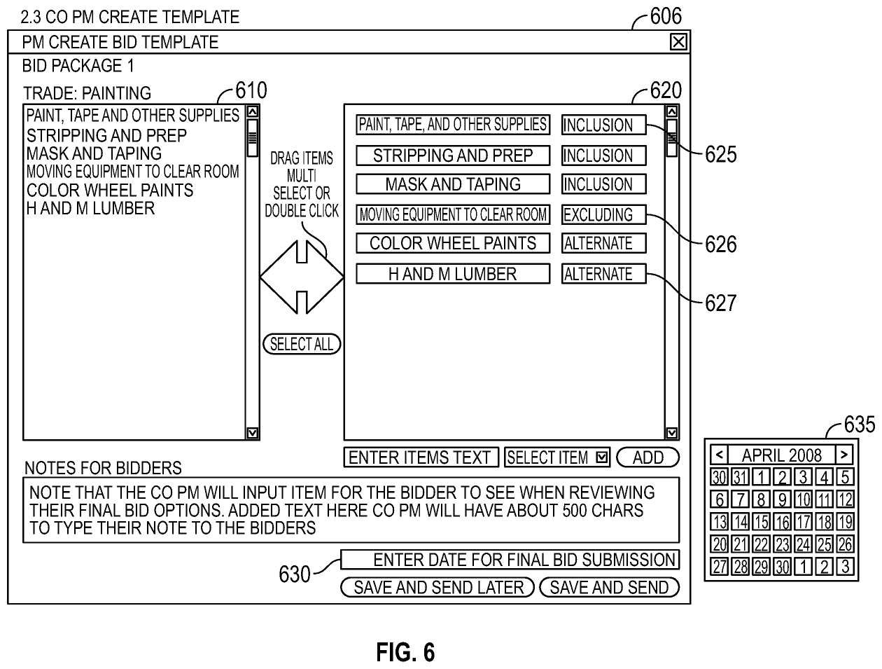

At 226, the machine prompts the user to create an “A2A” template, using the screen shown in FIG. 6. Each of the different bidders has created a bid with a number of line items, the line items being as shown, for example, in FIG. 3 as 310, 311, 312, 313 etc. Each bidder has submitted a bid with their own line items. All of the different bids are combined together, and each of the line items from each of the different bids then appear as different possible products or services, in the left screen 610 of the template creation unit in the create template menu 600. The contractor, who is comparing these bids, decides which of these items in the list 610 that the contractor wants to include within the final bid. For example, the contractor may include some or all of those line items into the final bid. The items in the left window 610 are then dragged, selected or double clicked to appear in the right window 620.

For each of these items, the contractor selects from the drop down menu whether they want them included as inclusions such as 625, excluded such as exclusions 626, or alternate shown as 627. This bid template, which is created from the line items in the original multiple bids themselves, then forms the template which is sent as the final bid notification at 230 (in FIG. 2) to each of the bidders.

After filling out all of these items, a date for the final submission is entered at 630, selected from a pop-up calendar at 635.

At 230, after creating the final template, the contractor sends a final bid notification to each of the subcontractors who originally bid on the project, in essence requesting “best and final” bids.

Then, at 235, the contractor will review the final bid. Bids will be submitted in one embodiment the via an email link. This scenario is shown at 240. Another scenario at 245 is that the user logged in and submitted the bid via an uploading process. Another possibility, shown at 250, is that the bids can be created via a webpage created when the user clicks on a dashboard notification.

However the bid is received, the final bid is received by the different subs at 255.

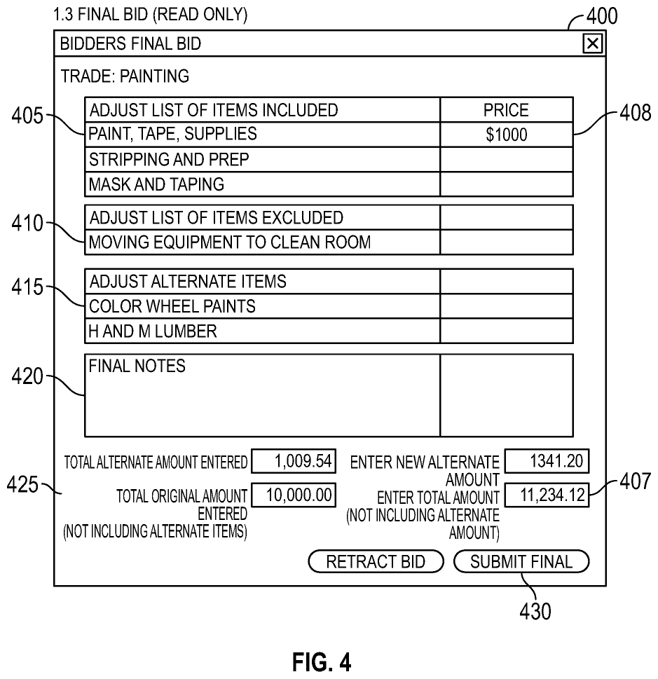

The final bid as 400 is shown in FIG. 4. This includes all of the different line items from all of the different bids, divided between included line items of 405, such as paint tape and supplies, stripping and prep, and masking and taping. It also includes the excluded items at 410, here moving equipment to clear the room. It also includes the alternate items at 415. For each of these items, the bidder enters a price such as the price 406. The system then adds the bids together to create a new total at 407. This new total represents all of the line items in item 4 of 5, which are all the line items that were selected for the template in FIG. 6 including all of the line items from all of the different bids from the different subcontractors.

The subcontractor can add any final notes at 420, thus creating a final bid which can be submitted by as the final bid at 430.

This has the effect of providing the bid on the contractors own form with the specifics of which items are included and excluded.

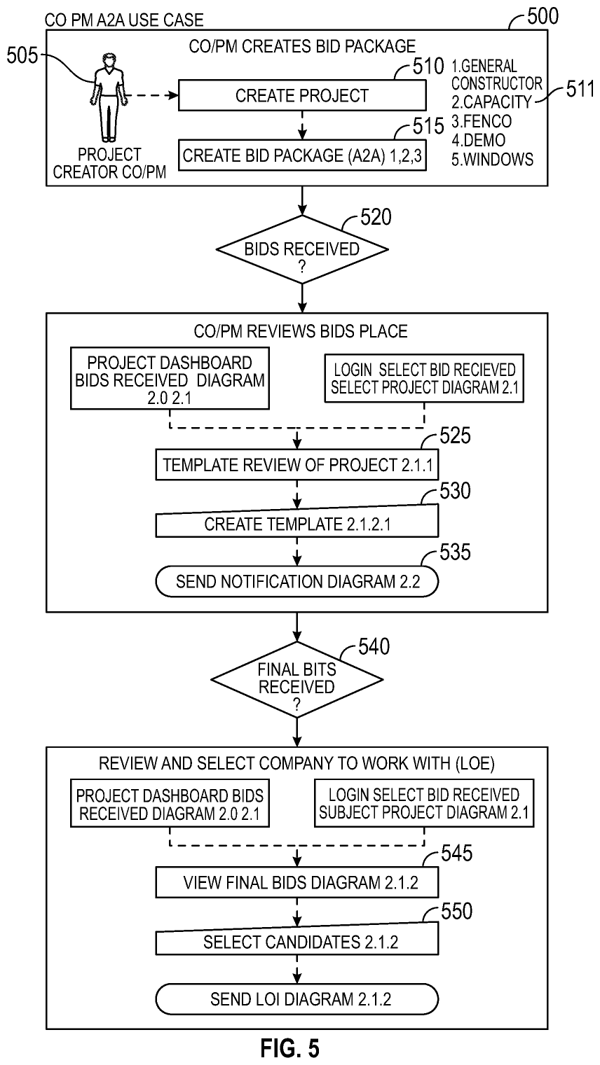

FIGS. 3 and 4 show the different views and operations that are seen by a bidder. In contrast, FIGS. 5 and 6 and 7 show the operations from the point of view of the contractor.

FIG. 5 illustrates how the contractor creates a bid package, and follows through the use case from beginning to end.

At 500, the project creator/contractor 505 creates a project 510 which includes the different aspects of the project 511, which is formed into a bid package at 515. These are sent to different subcontractors. The result is that bids from those subcontractors are received at 520.

At 525, the different line items from all the different bids are reviewed at 525 using the screen in FIG. 6, and used to create a template at 530. The template 530 is created from all the initial line items. This is followed by sending a notification of the bids at 535.

At 540 the final bids are received, and are viewed at 545. The contractor selects candidates at 550, and sends a letter of intent.

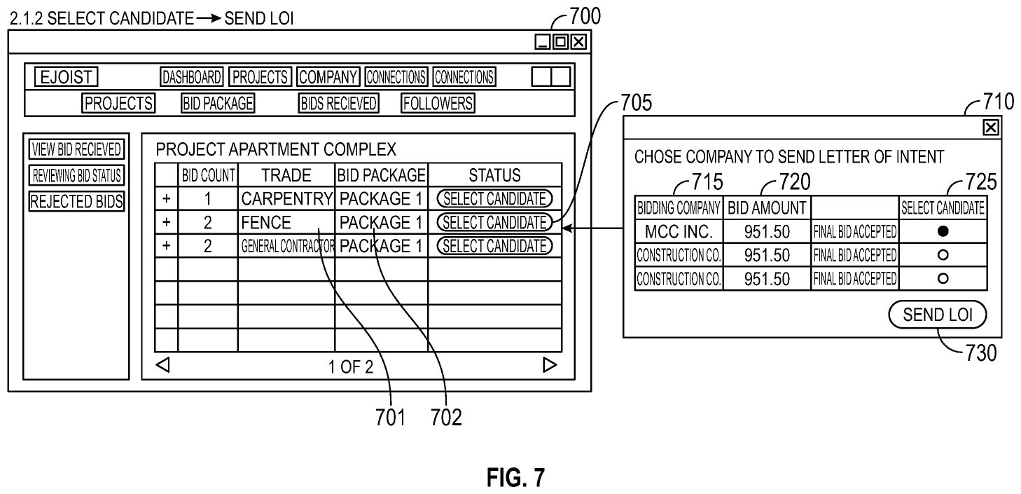

FIG. 7 illustrates the contractor being able to view all of the different bids for each of a plurality of different trades. FIG. 7 shows that there are different trades who have each wrist seethed at least one bid, here carpentry, fencing, and general contractors. For the fencing, shown in 701, there is a bid package that has already been created shown as 702. After receiving finalized bids, which can be for example requiring that all contractors have included in excluded the same items, the contractor can select the button 705 to bring up a selection screen 710. This selection screen includes the different bidders 715, the bid amounts 720, and allows the user to select one of the candidates. After selecting the candidate, a letter of intent can be autotically created by the buttom 730, and sent.

For all of these, the initial bids are used to create a plurality of different line items that are used in the final bids thus creating an apples to apples comparison.

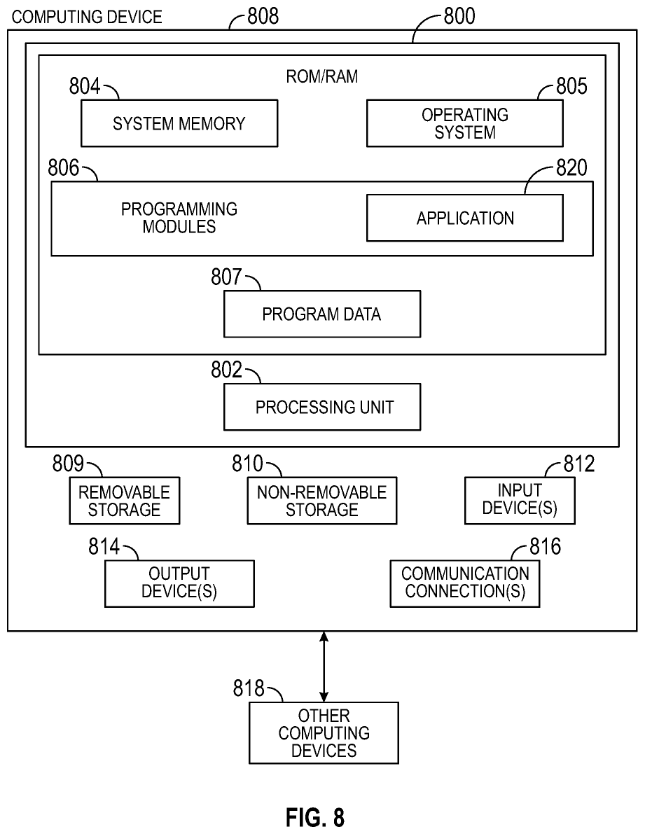

FIG. 8 shows the different parts of the processor that are used. With reference to FIG. 8, a system consistent with an embodiment of the disclosure may include a computing device or cloud service, such as computing device 800. In a basic configuration, computing device 800 may include at least one processing unit 802 and a system memory 804. Depending on the configuration and type of computing device, system memory 804 may comprise, but is not limited to, volatile (e.g. random-access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. In one embodiment, programming modules 806 may include machine learning module. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable and non-removable media implemented in any method or technology for storage of information, such as computer-readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, a location sensor, a camera, a biometric sensor, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet.

Communication connection 816 is one example of communication media. Communication media may typically be embodied by computer readable instructions, data structures, program modules, or other data in a modulated data signal, such as a carrier wave or other transport mechanism, and includes any information delivery media.

The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as 10 used herein may include both storage media and communication media. As stated above, a number of program modules and data files may be stored in system memory 804, including operating system 805. While executing on processing unit 802, programming modules 806 (e.g., application 820 such as a media player) may perform processes including, for example, one or more stages of methods, algorithms, systems, applications, servers, databases as described above.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

For example, in different embodiments, the bids can beplaced for things such as construction, painting, whitewash, gardening, construction material, furniture, and so on. Further, the details related to the bid may include factors such as price break-up, facilities provided, material used, individual tasks, individual prices, alternate options, project plans, specifications and other documents, and so on

What is claimed is:

1. A computer system for creating equalized bids, comprising:
a computer system, including a processor, and a memory, the processor executing instructions, which cause the computer to carry out operations for:
accepting a plurality of initial bids for a project in a specified trade, the initial bids formed of plural line items, each line item specifying a product or service associated with the specified trade for the project, and costs for the line items;
using the initial bids from each of a plurality of bidders to create a bid template by combining the line items from each of the plurality of bidders, and defining, for each line item, whether the product or service will be included in the bid, whether the product or service will be excluded from the bid, and/or whether the product or service will be an alternative to the bid to create an alternative cost for an additional product or service,
sending information about the bid template to the plurality of bidders, along with an ability for each of the bidders to enter an amount for each of the line items that are included in the bid as a bid amount, and
receiving bids based on the bid template and displaying the bids from the bid template.

2. The system as in claim 1, wherein the system allows bidders to create an initial bid package, by filling in line items and prices for the line items, and where the bid template is created by selecting line items from the initial bids and combining selected line items to form the bid template.

3. The system as in claim 1, wherein the information about the bid template sent to the bidders includes an email link to place the bids, which opens a webpage that includes the bid template.

4. The system as in claim 1, wherein the information about the bid template sent to the bidders includes information provided when the users login to the computer system.

5. The system as in claim 1, wherein the information about the bid template sent to the bidders includes a dashboard notification which leads to the bid template for the notification.

6. The computer system as in claim 1, wherein the computer system includes operations for comparing all the different bids that were created using the bid template, where all the different bids that were created using the bid template have the same scope of work, and selecting one of those bids as a selected bid.

7. The computer system as in claim 6, wherein the selecting the bid as a selected bid automatically sends a letter of intent to a selected bidder.

8. The computer system as in claim 1, where the information about the bid template is sent to each of the plurality of bidders.

9. The system as in claim 1, wherein the plurality of initial bids have each line item marked as included, excluded and/or alternate.
